(19) United States
(12) Patent Application Publication
(10) Pub. No.: US 2016/0353279 A1
(43) Pub. Date: Dec. 1, 2016

(54) IDENTIFIER STORING SERVER AND A METHOD FOR STORING IDENTIFIER

(71) Applicant: OPTiM CORPORATION, SAGA (JP)

(72) Inventor: SHUNJI SUGAYA, TOKYO (JP)

(21) Appl. No.: 15/162,684

(22) Filed: May 24, 2016

(30) Foreign Application Priority Data
May 26, 2015 (JP) 2015-106413

(51) Int. Cl. H04W 12/06; G06F 21/88; H04W 12/08; H04W 4/02; H04W 4/00

(52) U.S. Cl. CPC H04W 12/06; H04W 4/02; H04W 4/008; H04W 12/08; G06F 21/88

(57) ABSTRACT

The present invention is to provide an identifier storing server and a method of storing identifier that is low-cost and also enables to easily grasp the situation at loss or theft of the portable terminal. The identifier storing server acquires the identifier related to the local network to which the portable terminal 100 is connected, acquires a registration notification associated with the identifier of the portable terminal 100 from the user terminal 200, acquires a connection request transmitted from the portable terminal 100 to the router 300, and transmits an alert notification if judging that the acquired connection request is received from the portable terminal 100 associated with the received registration notification.

### CROSS REFERENCE TO RELATED APPLICATIONS

This application claims priority to Japanese Patent Application No. 2015-106413 filed on May 26, 2015, the entire contents of which are incorporated by reference herein.

### TECHNICAL FIELD

The present invention is related to an identifier storing server communicatively connected with a plurality of user terminals and with a communication device, the communication device being communicatively connected with the plurality of user terminals, and a method of storing identifier.

### BACKGROUND ART

Recently, as portable terminals such as smart phone and tablet terminal becomes more widespread, the chance to store a personal information and corporate confidential information, etc. in the portable terminal increases. Therefore, the leakage of the personal information or the confidential information at loss or theft of the portable terminal becomes a problem.

A system for monitoring a portable terminal executing a near field communication between the cradle and the terminal against the loss or theft of the portable terminal is disclosed (Refer to Patent Document 1).

### CITATION LIST

### Patent Literature

Patent Document 1: JP 2013-41518A

### SUMMARY OF INVENTION

According to Patent Document 1, by judging that the terminal is not stolen when the near field communication is executed between the cradle and the terminal or that the terminal is stolen when the near field communication is not executed between the cradle and the terminal, it is possible to save the time of the security countermeasures for the release and relock of security wire and also improve convenience.

However, the cost of such method may be expensive because a dedicated device such as cradles need to be prepared separately and it may be difficult to grasp the present status of the terminal at loss or theft.

Therefore, the present invention focuses on grasping the status of the portable terminal at loss or theft by enabling a communication between portable terminal and communication device without introducing a dedicated device.

Accordingly, an objective of the present invention is to provide an identifier storing server and a method of storing identifier that is low-cost and also enables to easily grasp the situation at loss or theft of the portable terminal.

The first aspect of the present invention provides an identifier storing server communicatively connected with a plurality of user terminals and with a communication device, the communication device being communicatively connected with one user terminal of the plurality of user terminals, including:

an identifier acquisition unit that acquires the identifier of a local network to which the one user terminal is connected;

a registration notification acquisition unit that acquires a registration notification associated with the identifier of the one user terminal from a user terminal different from the one user terminal;

a connection request acquisition unit that acquires a connection request transmitted from the one user terminal to the communication device; and

an alert notification transmitting unit that transmits an alert notification if judging that the acquired connection request is received from the one user terminal associated with the received registration notification.

According to the first aspect of the present invention, an identifier storing server communicatively connected with a plurality of user terminals and with a communication device, the communication device being communicatively connected with one user terminal of the plurality of user terminals acquires the identifier of a local network to which the one user terminal is connected, acquires a registration notification associated with the identifier of the one user terminal from a user terminal different from the one user terminal, acquires a connection request transmitted from the one user terminal to the communication device, and transmits an alert notification if judging that the acquired connection request is received from the one user terminal associated with the received registration notification.

The first aspect of the invention belongs to the category of an identifier storing server but has the same working effects under different categories such as a method of storing identifier.

The second aspect of the present invention provides the identifier storing server according to the first aspect of the present invention, in which the alert notification unit notifies the alert notification by email.

According to the second aspect of the present invention, the identifier storing server according to the first aspect of the present invention notifies the alert notification by email.

The third aspect of the present invention provides the identifier storing server according to the first aspect of the present invention, in which the alert notification unit notifies the alert notification by voice.

According to the third aspect of the present invention, the identifier storing server according to the first aspect of the present invention notifies the alert notification by voice.

The fourth aspect of the present invention provides the identifier storing server according to the first aspect of the present invention, further including a location information acquisition unit that acquires the location information of the communication device, in which the alert notification unit transmits an alert notification to which the location information is added.

According to the fourth aspect of the present invention, the identifier storing server according to the first aspect of the present invention acquires the location information of the communication device, and transmits an alert notification to which the location information is added.

According to fifth aspect of the present invention, a method for storing identifier, executed by an identifier storing server communicatively connected with a plurality of user terminals and with a communication device, the communication device being communicatively connected with one user terminal of the plurality of the user terminals, including the steps of

acquiring the identifier of a local network to which the one user terminal is connected;

acquiring a registration notification associated with the identifier of the one user terminal from a user terminal different from the one user terminal;

acquiring a connection request transmitted from the one user terminal to the communication device; and

transmitting an alert notification if judging that the acquired connection request is received from the one user terminal associated with the received registration notification.

The present invention can provide an identifier storing server and a method of storing identifier that is low-cost and also enables to easily grasp the situation at loss or theft of the portable terminal.

### BRIEF DESCRIPTION OF DRAWINGS

FIG. 1 shows an overview of the identifier storing system 1.

FIG. 2 is the overall schematic diagram of the identifier storing system 1.

FIG. 3 is a functional block diagram of the identifier storing server 10, the portable terminal 100, the user terminal 200, and the router 300.

FIG. 4 is a flow chart of the lost registration process executed by the identifier storing server 10, the portable terminal 100, and the user terminal 200.

FIG. 5 is a flow chart of the alert notification process executed by the identifier storing server 10, the portable terminal 100, the user terminal 200, and the router 300.

FIG. 6 shows the user information registration table that identifier storing server 10 stores.

FIG. 7 shows the lost notification input screen that the user terminal 200 displays.

FIG. 8 shows the notification alert screen that the user terminal 200 displays.

### DESCRIPTION OF EMBODIMENTS

Embodiments of the present invention are described below with reference to the attached drawings. However, this is illustrative only, and the technological scope of the present invention is not limited thereto.

### Overview of Identifier Storing System 1

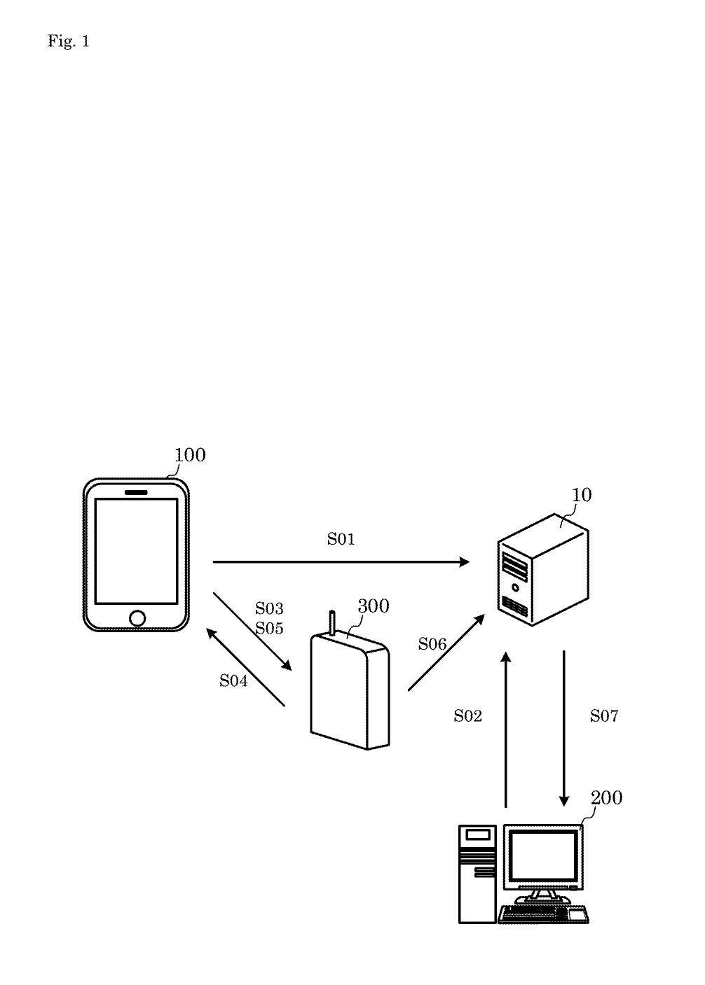

The overview of the present invention will be described below with reference to FIG. 1. The identifier storing server 10 is a server communicatively connected with the portable terminal 100, the user terminal 200, and the router 300. Moreover, the portable terminals 100 may be the general information consumer electronics such as a mobile phone, a smart phone, a net book terminal, a slate terminal, an electronic book terminal, an electronic dictionary terminal, a portable music player, and a portable player and recorder. The user terminals 200 may be the general information consumer electronics described above, general computer equipment such as a desktop personal computer, and a laptop personal computer. The router 300 is a general gateway device forming a local area network together with a plurality of the portable terminals 100. The plurality of the portable terminals 100 are communicatively connected with a public line network 5 through the router 300.

One user terminal among from the plurality of the user terminals described above corresponds to the portable terminal 100. The other user terminals among from the plurality of the user terminals described above corresponds to the user terminal 200. Moreover, the communication device described above corresponds to the router 300. The identifier storing server described above corresponds to the identifier storing server 10.

First, the portable terminal 100 transmits its identifier to the identifier storing server 10 (step S01). In step S01, the identifiers transmitted from the portable terminal 100 are such as a terminal's MAC address, a dedicated number of the terminal, a production number, a user name assigned to the terminal, and a user ID associated with the user name. Moreover, in step S01, for its identifiers transmitted from the portable terminal 100, at least the MAC address which is the identifier related to the local network needs to be transmitted and the other identifiers can be changed as appropriate.

The identifier storing server 10 stores the received identifier of the portable terminal 100.

The user terminal 200 transmits the lost notification of the portable terminal 100 to the identifier storing server 10 (step S02). In step S02, the user terminal 200 transmits, as a lost notification, the identifiers to identify the terminal such as the user name or the telephone number of the portable terminal 100, date and time last seen, an email address, and a telephone number of the destination of the lost notification. Moreover, in step S02, for the identifiers of the portable terminal 100 transmitted from the user terminal 200, at least the MAC address of the portable terminal 100 needs to be transmitted and the other identifiers can be changed as appropriate.

The identifier storing server 10 receives the lost notification transmitted from the user terminal 200. The identifier storing server 10 associates and stores the lost notification received from the user terminal 200 and the identifier received from the portable terminal 100.

The portable terminal 100 transmits a connection request to the router 300 (step S03). The router 300 receives the connection request from the portable terminal 100. The router 300 transmits an identifier acquisition request to the portable terminal 100 that has transmitted this connection request (step S04). The portable terminal 100 receives the identifier acquisition request from the router 300. The portable terminal 100 transmits its MAC address to the router 300 based on the received identifier acquisition request (step S05).

The Router 300 transmits the received MAC address of the portable terminal 100 to the identifier storing server 10 (step S06). The identifier storing server 10 receives this MAC address. The identifier storing server 10 retrieves the MAC address for which the lost notification has been registered and stored based on the received MAC address. If judging that the MAC address received this time is one of the MAC addresses for which the lost notification has been registered and stored, the identifier storing server 10 generates an alert notification.

The identifier storing server 10 transmits the generated alert notification to the user terminal 200 (step S07). In step S07, the identifier storing server 10 executes an alert notification by email that notifies a location where the terminal is detected, an area map of this location, and a comment related to the circumstances of detection by sending an email to the email address of the user terminal 200. The identifier storing server 10 also executes an alert notification by voice that notifies a location where the terminal is detected, area information on this location, and a comment related to the circumstances of detection by calling the telephone number of the user terminal 200. Moreover, the identifier storing server 10 also executes an alert notification through the dedicated application that notifies a location where the terminal is detected, an area map of this location, and a comment related to the circumstances of detection.

The user terminal 200 displays the transmitted alert notification. In case the alert notification by email is executed, an email application is started and displays the email body text. In case an alert notification by voice is executed, a telephone application is started, receives an incoming call, and transmits the received voice notification by voice. Moreover, in case an alert notification through the dedicated application is executed, a corresponding application is started and displays the alert notification.

### Configuration of the Identifier Storing System 1

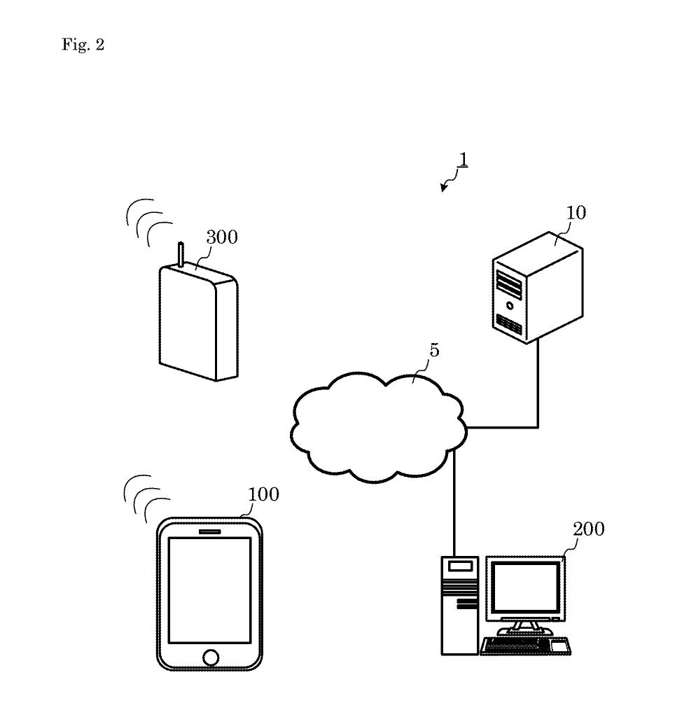

FIG. 2 is a block diagram illustrating the system of the identifier storing system 1 according to a preferable embodiment of the present invention. The identifier storing system 1 includes an identifier storing server 10, a portable terminal 100, a user terminal 200, a router 300, and a public line network 5.

The portable terminal 100 is communicatively connected with the router 300. The router 300 is also communicatively connected with the identifier storing server 10 through a public line network 5. Moreover, the user terminal 200 is communicatively connected with the identifier storing server 10 through a public line network 5. Furthermore, the identifier storing server 10, the portable terminal 100, the user terminal 200, and the router 300 may be directly and communicatively connected respectively or individually through the near field communication, etc.

The portable terminal 100 may be a general information terminal, which is an information device or an electrical appliance with functions to be described later. Examples of the portable terminal 100 include, as described above, the general information consumer electronics such as a mobile phone, a smart phone, a net book terminal, a slate terminal, an electronic book terminal, an electronic dictionary terminal, a portable music players, and a portable content player and recorder.

The user terminal 200 may be a general information terminal, which is an information device or an electrical appliance with functions to be described later. Examples of the user terminals 200 includes, as described above, information processing devices such as the general information consumer electronics and computers.

Moreover, the router 300 is a general gateway device forming a local area network together with the plurality of the portable terminals 100. The router 300 also has functions to be described later. The plurality of the portable terminals 100 are communicatively connected with a public line network through the router 300.

The identifier storing server 10 is a server device with functions to be described later.

### Functions

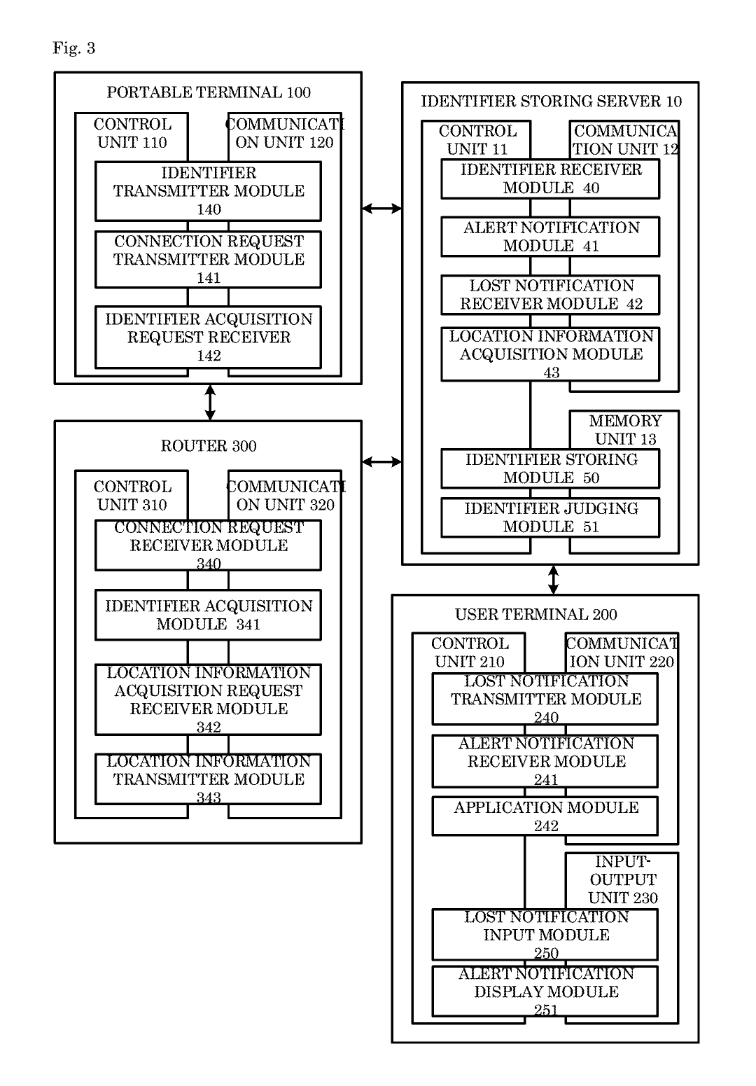

FIG. 3 shows the relationship among the respective functions of the identifier storing server 10, the portable terminal 100, the user terminal 200, and the router 300.

The identifier storing server 10 is provided with a control unit 11 including a central processing unit (hereinafter referred to as “CPU”), a random access memory (hereinafter referred to as “RAM”), and a read only memory (hereinafter referred to as “ROM”); and a communication unit 12 including a Wireless Fidelity or Wi-Fi® enabled device complying with, for example, IEEE 802.11, or a wireless device complying with the IMT-2000 standard such as the third generation mobile communication system. The communication unit may include a wired device for LAN connection.

The identifier storing server 10 also includes a storage unit as a memory unit 13 such as a hard disk or a semiconductor memory to store data, and stores the user information registration table described later.

In the identifier storing server 10, the control unit 11 reads a predetermined program and cooperates with the communication unit 12 to achieve an identifier receiver module 40, an alert notification module 41, a lost notification receiver module 42, and a location information acquisition module 43. Moreover, in the identifier storing server 10, the control unit 11 reads a predetermined program and cooperates with the memory unit 13 to achieve an identifier storing module 50 and an identifier judging module 51.

The portable terminal 100 is provided with a control unit 110 including a CPU, a RAM, and a ROM; and a communication unit 120 including a Wi-Fi® enabled device complying with, for example, IEEE 802.11, or a wireless device complying with the IMT-2000 standard such as the third generation mobile communication system. The communication unit may include a wired device for LAN connection.

In the portable terminal 100, the control unit 110 reads a predetermined program and cooperates with the communication unit 120 to achieve an identifier transmitter module 140, a connection request transmitter module 141, and an identifier acquisition request receiver module 142.

The user terminal 200 includes a control unit 210 including a CPU, a RAM, and a ROM; and a communication unit 220 including a Wireless Fidelity or Wi-Fi® enabled device complying with, for example, IEEE802.11, or a wireless device complying with the IMT-2000 standard such as the third generation mobile communication system. The communication unit 220 may include a wired device for LAN connection.

The user terminal 200 also includes an input-output unit 230 including a display unit outputting and displaying data and images that have been processed by the control unit 1 210; and also including a touch panel, a keyboard, and a mouse that receive an input from a user.

In the user terminal 200, the control unit 210 reads a predetermined program and cooperates with the communication unit 220 to achieve a lost notification transmitter module 240, an alert notification receiver module 241, and an application module 242. Moreover, the control unit 210 reads a predetermined program and cooperates with the input-output unit 230 to achieve a lost notification input module 250 and an alert notification display module 251.

The router 300 includes a control unit 310 including a CPU, a RAM, and a ROM; and a communication unit 320 including a Wireless Fidelity or Wi-Fi® enabled device complying with, for example, IEEE802.11, or a wireless device complying with the IMT-2000 standard such as the third generation mobile communication system. The communication unit 320 may include a wired device for LAN connection.

In the router 300, the control unit 310 reads a predetermined program and cooperates with the communication unit 320 to achieve a connection request receiver module 340, an identifier acquisition module 341, a location information acquisition request receiver module 342, and a location information transmitter module 343.

### Lost Registration Process

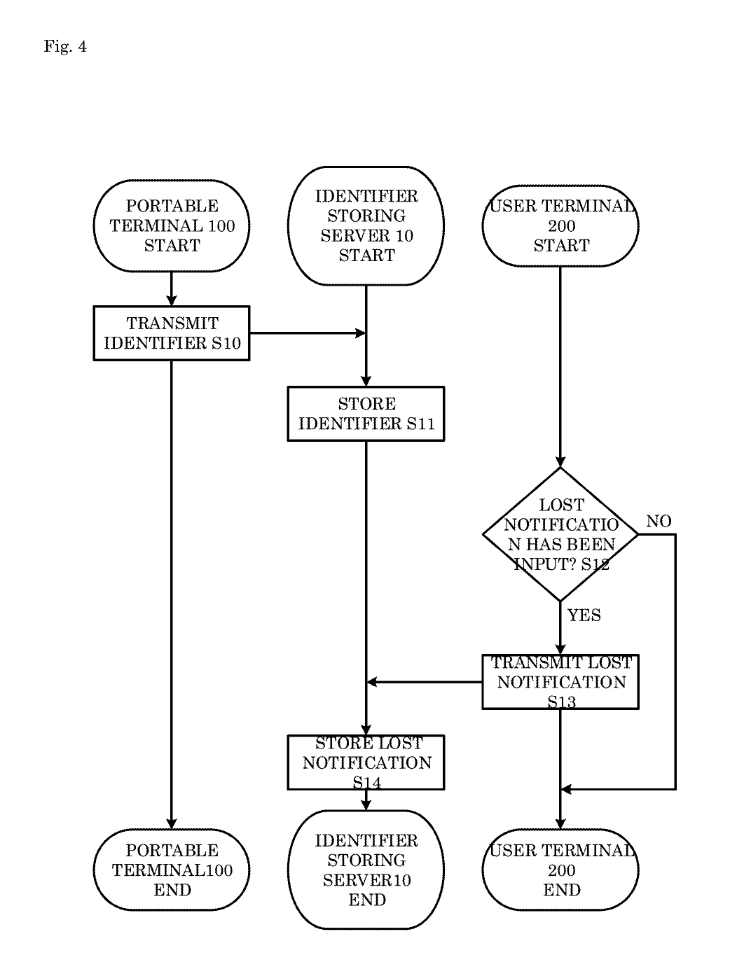

FIG. 4 is a flow chart of the lost registration process executed by the portable terminal 100, the identifier storing server 10, and the user terminal 200. The tasks executed by the modules of each of the above-mentioned units will be explained below together with this process.

First, the identifier transmitter module 140 of the portable terminal 100 transmits the identifier related to the local network and the identifiers that identify itself to the identifier storing server 10 (step S10). In step S10, the identifiers transmitted from the identifier transmitter module 140 are such as a MAC address, an owner's name, a telephone number, a production number, a dedicated number of the terminal, and SIM ID.

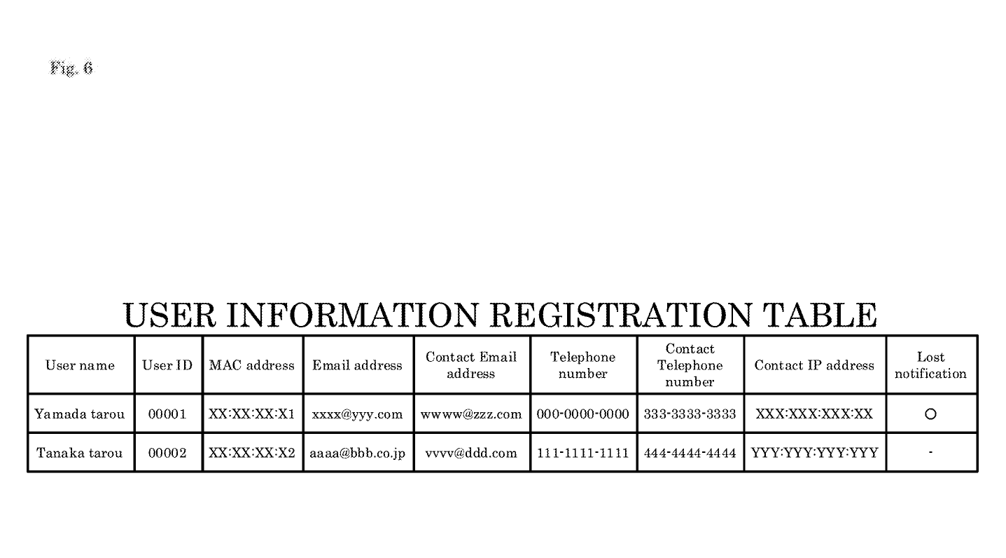

The identifier receiver module 40 of the identifier storing server 10 receives the identifiers transmitted from the portable terminal 100. The identifier storing module 50 of the identifier storing server 10 stores the identifiers received from the portable terminal 100 in the user information registration table shown in FIG. 6 (step S11).

FIG. 6 shows the user information registration table that the identifier storing module 50 stores. In FIG. 6, the identifier storing module 50 associates and stores a user name, a user ID, a MAC address, an email address, a contact email address, a telephone number, a contact telephone number, a contact IP address, and a lost notification. The details of the contact email address, the contact telephone number, the contact IP address, and the lost notification are described later. The identifier storing module 50 associates and stores each above-mentioned identifier received from the portable terminal 100 with the contact email address, the contact telephone number, the contact IP address, and the lost notification. In the user information registration table, the user name, the user ID, the MAC address, the email address, and the telephone number are identifiers of the portable terminal 100. The contact email address and the contact telephone number is respectively the contact email address and the contact telephone number of the user terminal 200 that transmits the alert notification described later. Moreover, the contact IP address is the IP address of the user terminal 200 that executes the alert notification described later. Furthermore, the lost notification shows whether or not the lost notification described later is registered.

In the user information registration table that identifier storing module 50 stores, any other items may be associated and registered without limitation to the items describe above. Moreover, either of above-mentioned items may be registered in the user information registration table. In this case, at least the MAC address has to be associated and stored with the lost notification and the other items can be changed as appropriate.

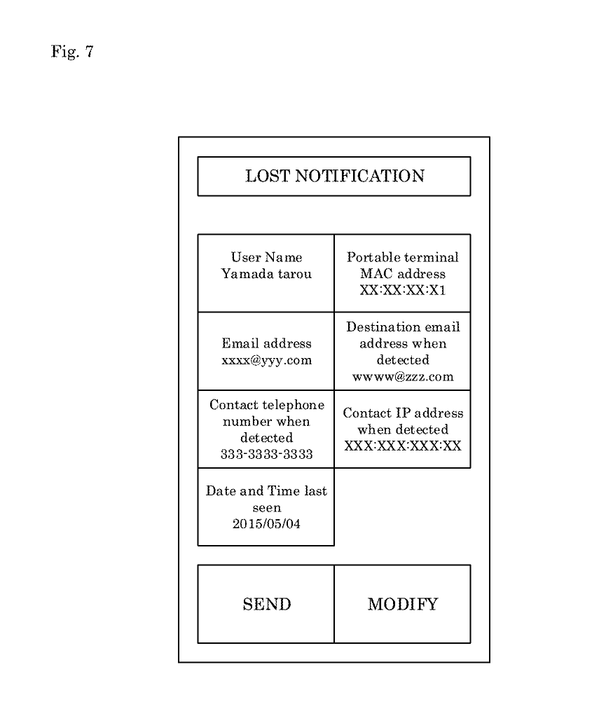

Then, the lost notification input module 250 of the user terminal 200 judges whether or not a lost notification of the user terminal 100 has been input (step S12). The lost notification input module 250 displays the lost notification input screen shown in FIG. 7 in response to the user's starting a predetermined application.

FIG. 7 shows the lost notification input screen that the lost notification module 250 displays. In FIG. 7, the lost notification input module 250 receives the input for each item of the lost portable terminal 100 such as a user name, a portable terminal MAC address, date and time last seen, an email address, a destination email address when detected, a contact telephone number when detected, and a contact IP address when detected. In the alert process described later, the destination email address when detected received by the lost notification input module 250 is the email address that receives an alert notification by email. Moreover in the alert process described later, the contact telephone number when detected received by the lost notification input module 250 is the telephone number of the user terminal 200 that executes the alert notification by voice notification. Furthermore, in the alert process described later, the contact IP address when detected received by the lost notification input module 250 is the IP address of the user terminal 200 that is the target to which a predetermined application executes an alert notification. The lost notification input module 250 may receive the user's direct input for each item, or the selection from a predetermined set for each item, or otherwise any one of the content selected from a plurality of the predetermined set of content for each item.

For the lost notification input module 250, any other items may be added without limitation to the items describe above. The lost notification input module 250 also at least has to receive the input of the MAC address and may not receive the input of the other items.

In step S12, if judging that the lost notification has not been input (NO), the lost notification input module 250 terminates this process. On the other hand, in step S12, if the lost notification input module 250 judges that the lost notification has been input (YES), the lost notification transmitter module 240 of the user terminal 200 transmits the lost notification for which the lost notification input module 250 received the input to the identifier storing server 10 (step S13).

The lost notification receiver module 42 of the identifier storing server 10 receives the lost notification transmitted from the user terminal 200. The identifier storing module 50 of the identifier storing server 10 stores the lost notification received from the user terminal 200 (step S14).

In step S14, the identifier storing module 50 of the identifier storing server 10 retrieves the MAC address registered in the user information registration table based on the MAC address included in the received lost notification. The identifier storing module 50 associates and stores this MAC address with the items included in the lost notification such as the contact email address, the contact telephone number, and the contact IP address and the lost notification.

The lost notification input module 250 may receive the input of the lost notification by email. In this case, the lost notification input module 250 also receives a lost notification which includes each above-mentioned item in the email body text or in the email attachments. The lost notification transmitter module 240 only has to transmit this email to the identifier storing server 10.

Moreover, the lost notification input module 250 may receive the input of the lost notification by telephone. In this case, the lost notification input module 250 may receive each above-mentioned item by key input as a lost notification while calling and the lost notification transmitter module 240 only has to transmit the received key input to the identifier storing server 10. Furthermore, the lost notification input module 250 may receive each above-mentioned item by voice input as a lost notification and the lost notification transmitter module 240 only has to transmit the received voice input to the identifier storing server 10.

The lost notification input module 250 may receive the input for each above-mentioned item of the lost notification on a predetermined website. In this case, the lost notification input module 250 may transmit the lost notification from a server device having a predetermined website to the identifier storing server 10.

### Alert Notification Process

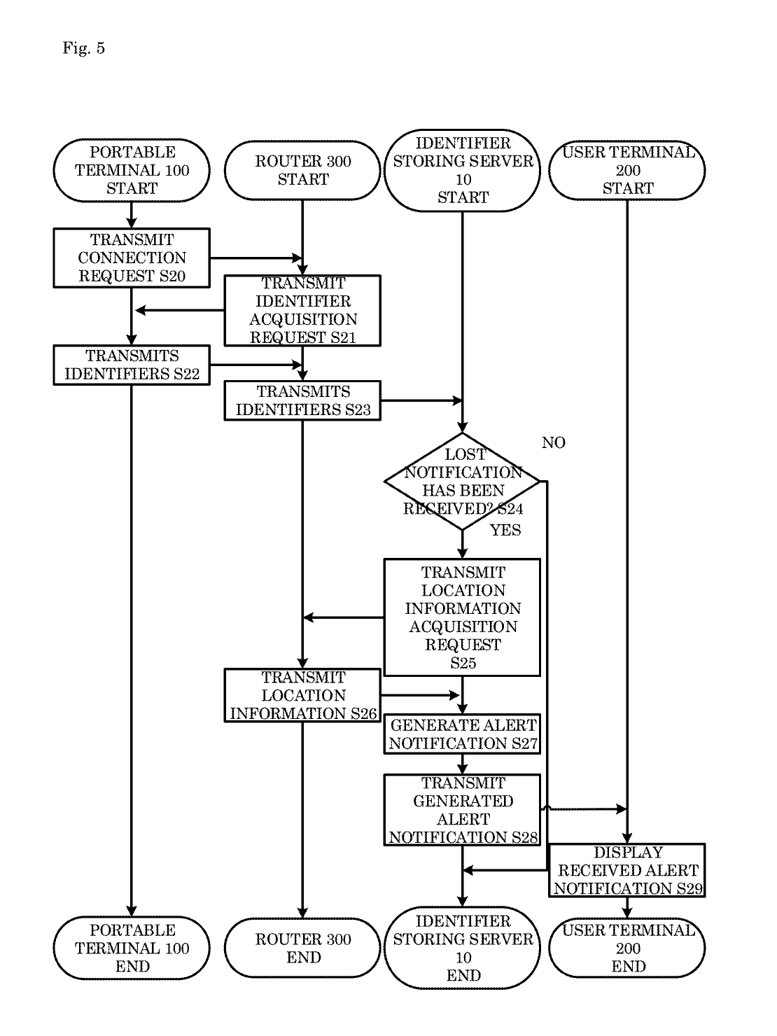

FIG. 5 is a flow chart of the alert notification process executed by the portable terminal 100, the identifier storing server 10, the user terminal 200, and the router 300. The tasks executed by the modules of each of the above-mentioned units will be explained below together with this process.

The connection request transmitter module 141 of the portable terminal 100 transmits the connection request to the local network to the router 300 (step S20).

The connection request receiver module 340 of the router 300 receives the connection request transmitted from the portable terminal 100. The identifier acquisition module 341 of the router 300 transmits an identifier acquisition request that is the request to acquire the identifier of the user terminal 100 that has transmitted this connection request (step S21).

The identifier acquisition request receiver module 142 of the portable terminal 100 receives the identifier acquisition request transmitted from the router 300. The identifier transmitter module 140 of the portable terminal 100 transmits its MAC address which is the identifier related to the local network to the router 300 based on the received identifier acquisition request (step S22).

The identifier acquisition module 341 of the router 300 receives the MAC address transmitted from the portable terminal 100. The Identifier transmitter module 140 of the router 300 transmits the received MAC address of the portable terminal 100 to the identifier storing server 10 (step S23).

The identifier receiver module 40 of the identifier storing server 10 receives the MAC address of the portable terminal 100 transmitted from the router 300. The identifier judging module 51 of the identifier storing server 10 retrieves the MAC address registered in the user information registration table based on the received MAC address of portable terminal 100. The identifier judging module 51 judges whether or not the MAC address received this time to be already registered in the user information table and to be associated with a lost notification (step S24).

In step S24, if judging that the lost notification has not been registered (NO), the identifier judging module 51 terminates this process. On the other hand, in step S24, if the identifier judging module 51 judges that the lost notification has been registered (YES), the location information acquisition module 43 of the identifier storing server 10 transmits a location information acquisition request to the router 300 that has transmitted the MAC address of the portable terminal 100 this time (step S25).

The location information acquisition request receiver module 342 of the router 300 receives the location information acquisition request transmitted from the identifier storing server 10. The location information transmitter module 343 of the router 300 transmits its location information to the identifier storing server 10 based on the received location information acquisition request (step S26).

In step S26, the router 300 acquires its location information by GPS and transmits it to the identifier storing server 10, or the location information is registered beforehand and the router 300 acquires this registered location information and transmits it to the identifier storing server 10, or otherwise the router 300 acquires the location information of the portable terminal 100 and transmits the acquired location information to the identifier storing server 10 as its location information. The router 300 may acquire its location information by other methods and transmit it to the identifier storing server 10.

The alert notification module 41 of the identifier storing server 10 generates an alert notification (step S27). In step S27, the alert notification module 41 generates a detection notification, character information related to the detected location, map information around the detected location, and a comment related to the circumstances of detection as an alert notification.

The alert notification module 41 generates information on the detected location based on the location information acquired from the router 300. For example, the alert notification module 41 transmits the location information acquired from the router 300 to the dedicated server such as the map servers, acquires location information on the detected location or information on the detected location such as a location name, a store name, and a building name, and generates the information on the acquired detected location as the character information related to the detected location. Moreover, the alert notification module 41 generates the map information around the detected location based on the location information acquired from the router 300. For example, the alert notification module 41 transmits the location information acquired from the router 300 to the dedicated server such as the map servers, acquires the map information related to the area map of the detected location, and generates this map information as the map information around the detected location. Furthermore, the alert notification module 41 acquires the date and time when the MAC address is received from the router 300 and generates the information that shows this date and time, its detected location, etc. as a comment related to the circumstances of detection. For the alert notification that the alert notification module 41 generates, any item may be changed as appropriate without limitation to the items describe above.

The alert notification module 41 of the identifier storing server 10 transmits the generated alert notification to the user terminal 200 (step S28).

In step S28, the alert notification receiver module 241 of the user terminal 200 may receive an alert notification as email. In this case, the alert notification module 41 of the identifier storing server 10 retrieves the contact email address associated with the MAC address received in step S24. For the retrieved contact email address, the alert notification module 41 creates an email body text or an email attachments including the detection notification, the character information related to the detected location, the map information around the detected location, and the comment related to the circumstances of detection that are described above to generate an alert notification. The alert notification module 41 transmits this email to the user terminal 200 that having the registered contact email address. Instead of including each above-mentioned item in the email body text or adding an email attachments that describes each item to the email, the alert notification module 41 may include a URL of the website describing each above-mentioned item in the email body text or in the email attachments and transmit the alert notification to the user terminal 200.

Moreover, in step S28, the alert notification receiver module 241 of the user terminal 200 may receive an alert notification as voice notification by telephone. In this case, the alert notification module 41 of the identifier storing server 10 retrieves the contact telephone number associated with the MAC address received in step S24. The alert notification module 41 creates an voice notification including the detection notification, the character information related to the detected location, the map information around the detected location, and the comment related to the circumstances of detection that are described above to generate an alert notification. The alert notification module 41 make an outgoing call to the user terminal 200 having the retrieved contact telephone number.

Furthermore, in step S28, the alert notification receiver module 241 of the user terminal 200 may receive an alert notification by a dedicated application. In this case, the alert notification module 41 of the identifier storing server 10 retrieves the contact IP address associated with the MAC address received in step S24. The alert notification module 41 creates the information including the detection notification, the character information related to the detected location, the map information around the detected location, and the comment related to the circumstances of detection that are described above to generate an alert notification. The alert notification module 41 transmits this alert notification to the user terminal 200 having the retrieved contact IP address.

Moreover, in step S28, the identifier storing server 10 may transmit an alert notification to the user terminal 200 by any other method without limitation to the method describe above.

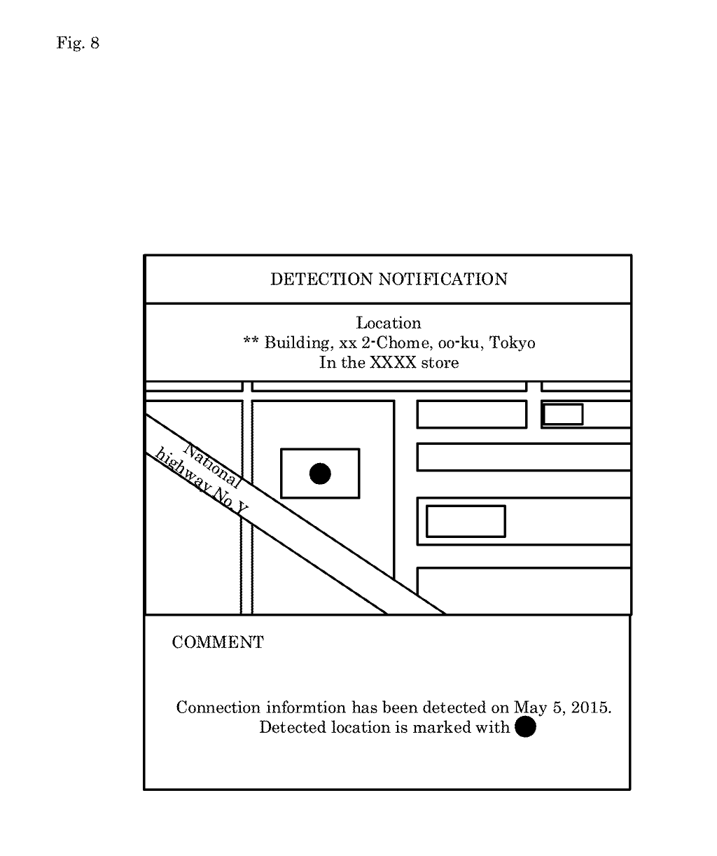

The alert notification receiver module 241 of the user terminal 200 receives the alert notification transmitted from the identifier storing server 10. The alert notification display module 251 of the user terminal 200 displays the received alert notification as the alert notification screen shown in FIG. 8 (step S29). FIG. 8 shows the notification alert screen that the user terminal 200 displays. In FIG. 8, the alert notification display module 251 displays the detection notification, the character information related to the detected location, the map information around the detected location, and the comment related to the circumstances of detection generated by the identifier storing server 10.

In step S29, when the alert notification display module 251 of the user terminal 200 receives an alert notification as email, the application module 242 of the user terminal 200 starts an email application. The alert notification display module 251 displays the alert notification through the email application that the application module 242 starts. Specifically, the application module 242 opens the received email by the email application and displays the received email body text and email attachments.

When a URL of the website describing each above-mentioned item is shown in the email body text or in the email attachments, the application module 242 receives a selection operation of the URL included in the displayed email body text or the email attachments, starts a web browser application, and displays the linked website of this URL.

Moreover, in step S29, when the alert notification display module 251 of the user terminal 200 receives an incoming call as alert notification, the application module 242 of the user terminal 200 starts a telephone application. The alert notification display module 251 displays the indication showing that the caller is the identifier storing server 10, or the telephone number of the telephone device connected with the identifier storing server 10 through the telephone application that application module 242 has been started. The alert notification display module 251 outputs the alert notification as voice through speakers, etc.

Furthermore, in step S29, when the alert notification display module 251 of the user terminal 200 receives the alert notification by the dedicated application, the application module 242 of the user terminal 200 starts a predetermined dedicated application. The alert notification display module 251 displays the received alert notification through the dedicated application started by the application module 242.

To achieve the means and the functions that are described above, a computer (including a CPU, an information processor, and various terminals) reads and executes a predetermined program. For example, the program is provided in the form recorded in a computer-readable medium such as a flexible disk, CD (e.g., CD-ROM), or DVD (e.g., DVD-ROM, DVD-RAM). In this case, a computer reads a program from the recording medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present invention are described above. However, the present invention is not limited to these embodiments. The effect described in the embodiments of the present invention is only the most preferable effect produced from the present invention. The effects of the present invention are not limited to that described in the embodiments of the present invention.

### REFERENCE SIGNS LIST

1 Identifier storing system

10 Identifier storing server

100 Portable terminal

200 User terminal

300 Router

What is claimed is:

1. An identifier storing server communicatively connected with a plurality of user terminals and with a communication device, the communication device being communicatively connected with one user terminal of the plurality of user terminals, comprising:
an identifier acquisition unit that acquires the identifier of a local network to which the one user terminal is connected;
a registration notification acquisition unit that acquires a registration notification associated with the identifier of the one user terminal from a user terminal different from the one user terminal;
a connection request acquisition unit that acquires a connection request transmitted from the one user terminal to the communication device; and
an alert notification transmitting unit that transmits an alert notification if judging that the acquired connection request is received from the one user terminal associated with the received registration notification.

2. The identifier storing server according to claim 1, wherein the alert notification unit notifies the alert notification by email.

3. The identifier storing server according to claim 1, wherein the alert notification unit notifies the alert notification by voice.

4. The identifier storing server according to claim 1, further comprising a location information acquisition unit that acquires the location information of the communication device, wherein the alert notification unit transmits an alert notification to which the location information is added.

5. A method for storing identifier, executed by an identifier storing server communicatively connected with a plurality of user terminals and with a communication device, the communication device being communicatively connected with one user terminal of the plurality of the user terminals, comprising the steps of:
acquiring the identifier of a local network to which the one user terminal is connected;
acquiring a registration notification associated with the identifier of the one user terminal from a user terminal different from the one user terminal;
acquiring a connection request transmitted from the one user terminal to the communication device; and
transmitting an alert notification if judging that the acquired connection request is received from the one user terminal associated with the received registration notification.
